(19) United States
(12) Patent Application Publication
(10) Pub. No.: US 2006/0248657 A1
(43) Pub. Date: Nov. 9, 2006

(54) Textile benefit compositions

(76) Inventors: Jiping Wang, West Chester, OH (US); Weidong Wu, Forest, VA (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/437,092

(22) Filed: May 19, 2006

Related U.S. Application Data
(63) Continuation-in-part of application No. 11/081,490, filed on Mar. 16, 2005.
(60) Provisional application No. 60/568,338, filed on May 5, 2004.

(51) Int. Cl. C11D 3/00

(52) U.S. Cl. 8/115.51

(57) ABSTRACT

The present invention relates to compositions and processes that can reduce and/or inhibit the color change that certain colored fibers under go and articles that are treated with such compositions and according to such processes. Such fibers may be treated in whole or in part, and may be treated before, during or after incorporation into an article such as a garment or linen.

### CROSS REFERENCE TO RELATED APPLICATIONS

This application claims priority under 35 U.S.C. § 120 and is a continuation-in-part of U.S. application Ser. No. 11/081,490, filed Mar. 16, 2005, which in turn claims priority under 35 U.S.C. § 119(e) to U.S. Provisional Application Ser. No. 60/568,338, filed May 5, 2004.

### FIELD OF INVENTION

This invention relates to treatment compositions, processes for using such compositions and treated articles.

### BACKGROUND OF THE INVENTION

Over time, articles that comprise certain colored fibers, for example, garments and linens experience a color shift. In certain instances, such color shift may be perceived as fading or even a color change. It is believed that such color shift may due in part to the non-selective deposition of materials, such as brighteners, on such articles. Brighteners are typically found in laundry and fabric care products as consumers prefer that their white fabrics maintain there whiteness and such materials can make white fabrics appear whiter. Thus, as most consumers prefer that the color of their articles, including colors other white, remain unchanged, there is a need for compositions and processes that reduce and/or inhibit such color change.

### SUMMARY OF THE INVENTION

The present invention relates to compositions and processes that can reduce and/or inhibit the color change that certain colored fibers under go and articles that are treated with such compositions and according to such processes.

### DETAILED DESCRIPTION OF THE INVENTION

### Definitions

As used herein, the term “textile products” includes, unless otherwise indicated, fibers, yarns, fabrics and/or garments or articles comprising same.

As used herein, the articles a and an when used in a claim are understood to mean one or more of what is claimed or described.

As used herein, the term “DMDHEU derivatives” mean the reaction product of DMDHEU and a one or more materials comprising one or more moieties selected from the group consisting of primary amines, secondary amines, —OH groups and combinations thereof.

Unless otherwise noted, all component or composition levels are in reference to the active level of that component or composition, and are exclusive of impurities, for example, residual solvents or by-products, which may be present in commercially available sources.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All documents cited are, in relevant part, incorporated herein by reference; the citation of any document is not to be construed as an admission that it is prior art with respect to the present invention.

### Process

Applicants recognized that the materials that may be at least in part responsible for fiber color shifts are negatively charged. Thus, while not being bound by theory, Applicants believe that the color change/shift of fibers can be reduced and/or eliminated by applying a negatively charged material to such fibers.

In one aspect a process comprising applying, to a fiber, based on total fiber weight, from about 0.1% to about 10%, from about 0.3% to about 8%, or even from about 0.5% to about 5% of a treatment composition comprising a material selected from the group consisting of:
(a) a reactive agent comprising one or more reactive moieties and one or more moieties that provide a negative charge;
(b) a reactive agent comprising two or more reactive moieties and an agent that comprises one or more moieties that provide a negative charge; and
(c) mixtures of (a) and (b)
   is disclosed.

In one aspect, said treatment composition may comprise (a) above.

In one aspect, said treatment composition may comprise (b) above.

In one aspect, the weight ratio of said reactive agent comprising two or more reactive moieties and said agent that comprises one or more moieties that provide a negative charge may be from about 1:10 to about 10:1, from about 1:5 to about 5:1, or even from about 1:3 to about 3:1.

In one aspect, said reactive agent comprising one or more reactive moieties and one or more moieties that provide a negative charge comprises a polycarboxylic acid.

In one aspect, said reactive agent comprising one or more reactive moieties and one or more moieties that provide a negative charge is selected from the group consisting of butanetetracarboxylic acid, polymaleic acid, succinic acid, malic acid and mixtures thereof.

In one aspect, said reactive agent comprising two or more reactive moieties is selected from the group consisting of dimethyloldihydroxyethylene urea (DMDHEU), DMDHEU derivatives, di-carboxylic acids, multi-carboxylic acids for example, butanetetracarboxylic acid, polymaleic acid, and mixtures thereof, and said agent that comprises one or more moieties that provide a negative charge comprises a moiety selected from a sulfonic group, carboxylic acid group, sulfuric group, phosphoric group, sulfide group and combinations thereof.

In one aspect, for (b) above, said agent that comprises one or more moieties that provides a negative charge comprises a sulfonic group.

In any of the foregoing aspects, a catalyst may be employed.

In one aspect, a process comprising applying, to a fiber, based on total fiber weight, from about 0.5% to about 5% of a treatment composition comprising a material selected from the group consisting of:
a.) a reactive agent comprising one or more reactive moieties and one or more moieties that provide a negative charge, said reactive agent comprising a material selected from the group consisting of butanetetracarboxylic acid, polymaleic acid and mixtures thereof;
b.) a reactive agent comprising two or more reactive moieties, said reactive agent comprising dimethyloldihydroxyethylene urea and said agent that comprises one or more moieties that provide a negative charge comprises a material selected from the group consisting of aminomethanesulfonic acid, taurine, isethionic acid and mixtures thereof; and
c.) mixtures of (a) and (b), and
d.) a catalyst selected from the group consisting of acids, latent acids and mixtures thereof
   is disclosed

Treatment may occur at any time but typically occurs prior to the fiber being used by the end user. Said treatment may occur in a textile mill. Such application step may comprise an operation selected from saturating, spraying, padding, exhaustion and combinations thereof. When said treatment's application step comprises padding, a sufficient amount of said textile treatment composition is typically removed from said textile product to achieve a wet pick-up of from about 30% to about 200%, from about 50% to about 150% or alternatively from about 60% to about 120%. When said treatment's contacting step comprises spraying, a sufficient amount of said textile treatment composition is typically removed from said textile product to achieve a wet pick-up of from about 10% to about 150%, from about 15% to about 100% or alternatively from about 20% to about 80%.

Useful equipment for practicing the method disclosed herein includes standard textile processing equipment including but not limited to batch, semi-continuous and continuous processing equipment and combinations thereof.

### Treated Articles

Articles comprising fibers having a deposition resistance to the deposition of materials such as brighteners may be made by treating, at a minimum, the article's fibers with a composition disclosed herein. In one aspect, only a portion of said fibers may be treated. In short, fibers may be selectively treated as certain colors, such as white, may benefit from brightener deposition. In another aspect all of such fibers may be treated. Such fibers may be treated before in corporation into said article, during incorporation into said article and/or after incorporation into said article. Treatment methods include the methods disclosed in the present specification.

### Treatment Compositions

Useful treatment compositions include the compositions detailed in the present specification including the process description, examples and claims. Such compositions may comprise an adjunct ingredient.

Useful reactive agents comprising one or more reactive moieties and one or more moieties that provide a negative charge include polycarboxylic acids. For example, butanetetracarboxylic acid, polymaleic acid, succinic acid, malic acid and mixtures thereof.

Useful reactive agents comprising two or more reactive moieties include dimethyloldihydroxyethylene urea (DMDHEU), DMDHEU derivatives, butanetetracarboxylic acid, polymaleic acid, other di or multi-carboxylic acids and mixtures thereof.

Useful agents that comprise one or more moieties that provide a negative charge include agents that comprise one or more of the following groups: sulfonic groups, carboxylic acid group, sulfuric group, phosphoric group, sulfide group and combinations thereof. For example, aminomethanesulfonic acid, taurine, isethionic acid and mixtures thereof.

Useful catalysts include acids, latent acids and mixtures thereof. For example, magnesium chloride for DMDHEU and its derivatives, and sodium hypophosphite for carboxylic acid reactive agent. Such catalyst may be formulated together with reactive agents or be added separately during applications.

Such agents and catalysts can be obtained from Aldrich, P.O. Box 2060, Milwaukee, Wis. 53201, USA.

In one aspect of Applicants' invention, such textile benefit compositions do not contain one or more of the following adjuncts materials: bleach activators, surfactants, builders, chelating agents, dye transfer inhibiting agents, dispersants, enzymes, and enzyme stabilizers, catalytic metal complexes, polymeric dispersing agents, clay and soil removal/anti-redeposition agents, brighteners, suds suppressors, dyes, perfumes, structure elasticizing agents, fabric softeners, carriers, hydrotropes, processing aids and/or pigments. Useful carriers may comprise water. For, example, a useful carrier is water.

The skilled artisan can produce the compositions of the present invention by following the teachings contained herein and in the examples as such compositions may be made by combining the requisite materials.

Commercial quantities of such compositions can be made using a variety of reaction vessels and processes including batch, semi-batch and continuous processes. Such equipment may be obtained from a variety of sources such as Lodige GmbH (Paderborn, Germany), Littleford Day, Inc. (Florence, Ky., U.S.A.), Forberg AS (Larvik, Norway), Glatt Ingenieurtechnik GmbH (Weimar, Germany), Niro (Soeborg, Denmark), Hosokawa Bepex (Minneapolis, Minn., USA).

### Adjunct Materials

While certain embodiments of Applicants textile benefit compositions do not contain one or more of the adjunct materials listed herein, as such adjuncts are not essential for the purposes of the present invention, other embodiments may contain one or more adjuncts illustrated hereinafter. Such adjuncts may be incorporated in the textile benefit compositions disclosed herein, for example to assist or enhance cleaning performance, or to modify the aesthetics of such compositions as is the case with perfumes, colorants, dyes or the like. The precise nature of these additional components, and levels of incorporation thereof, will depend on the physical form of the textile benefit composition and the nature of the operation for which it is to be used and applied. Useful adjunct materials may include, but are not limited to, bleach activators, surfactants, builders, chelating agents, dye transfer inhibiting agents, dispersants, enzymes, and enzyme stabilizers, catalytic metal complexes, polymeric dispersing agents, clay and soil removal/anti-redeposition agents, brighteners, suds suppressors, dyes, perfumes, structure elasticizing agents, fabric softeners, carriers, hydrotropes, processing aids and/or pigments.

### EXAMPLES I-IV

Textile benefit compositions having the following formulae are made in accordance with the method described below.

| | Trade | Example 1% | Example 2% | Example 3% | Example 4% |
|---|---|---|---|---|---|
| Material | name/Supplier | Formula | Formula | Formula | Formula |
| butanetetracarboxylic acid | Aldrich | 2.00% | 1.00% | 0.00% | 0.00% |
| polymaleic acid | Monomer sourced | 0.00% | 0.00% | 2.00% | 0.00% |
| | from Aldrich. | | | | |
| | Made in house | | | | |
| dimethyloldihydroxyethylene | Freerez | 0.00% | 0.00% | 0.20% | 3.00% |
| urea | 845/Noveon, Ohio | | | | |
| aminomethanesulfonic acid | Aldrich | 0.00% | 0.00% | 1.00% | 1.00% |
| taurine | | 0.00% | 1.00% | 0.00% | 1.00% |
| magnesium chloride | Aldrich | 0.00% | 0.00% | 0.00% | 1.00% |
| sodium hypophosphite | Aldrich | 0.50% | 0.40% | 0.75% | 0.00% |
| Wetting Agent | LEOPHEN ™ N- | 0.10% | 0.10% | 0.10% | 0.10% |
| | AM/BASF | | | | |
| Water | | Balance | Balance | Balance | Balance |
| Solution pH (adjusted by | | 3 | 3 | 3 | 4 |
| acetic acid) | | | | | |

For each of Examples I-IV the requisite components are pre-dissolved and then combined in a standard batch mixing vessel.

Fabric Treatment

Four lots of fabric samples are obtained and each lots is soaked with one of the compositions of Examples I-IV of above. The fabrics are then padded via Mathis Padder (Model #HVF 52200) at 3 bars of pressure with at a rate of 2 feet per minute. The wet pick-ups are in the range of 75%-100% on weight of fabrics. Fabrics are then dried at 50° C. for 2 hours before curing. These fabrics are cured on a continuous feed dryer for 4 minutes at 150° C. oven space temperature.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process comprising applying, to a fiber, based on total fiber weight, from about 0.1% to about 10%, from about 0.3% to about 8%, or even from about 0.5% to about 5% of a treatment composition comprising a material selected from the group consisting of:
(a) a reactive agent comprising one or more reactive moieties and one or more moieties that provide a negative charge;
(b) a reactive agent comprising two or more reactive moieties and an agent that comprises one or more moieties that provide a negative charge; and
(c) mixtures of (a) and (b).

2. A process according to claim 1 wherein said treatment composition comprises a catalyst.

3. A process according to claim 1 wherein said treatment composition comprises a reactive agent comprising one or more reactive moieties and one or more moieties that provide a negative charge.

4. A process according to claim 3 wherein said treatment composition comprises one or more moieties that provide a negative charge.

5. A process according to claim 3 wherein said treatment composition comprises a catalyst.

6. A process according to claim 4 wherein said treatment composition comprises a catalyst.

7. A process according to claim 1 wherein said treatment composition comprises a reactive agent comprising two or more reactive moieties and an agent that comprises one or more moieties that provide a negative charge.

8. A process according to claim 7 wherein said treatment composition comprises a catalyst.

9. A process according to claim 1 wherein for (b) the weight ratio of said reactive agent comprising two or more reactive moieties and said agent that comprises one or more moieties that provide a negative charge is from about 1:10 to about 10:1, from about 1:5 to about 5:1, or even from about 1:3 to about 3:1.

10. A process according to claim 1 wherein said reactive agent comprising one or more reactive moieties and one or more moieties that provide a negative charge comprises a polycarboxylic acid.

11. A process according to claim 10 wherein said reactive agent comprising one or more reactive moieties and one or more moieties that provide a negative charge is selected from the group consisting of butanetetracarboxylic acid, polymaleic acid, succinic acid, malic acid and mixtures thereof.

12. A process according to claim 1 wherein for (b) said reactive agent comprising two or more reactive moieties is selected from the group consisting of dimethyloldihydroxyethylene urea, dimethyloldihydroxyethylene urea derivatives, di-carboxylic acids, multi-carboxylic acids and mixtures thereof; and said agent that comprises one or more moieties that provide a negative charge comprises a moiety selected from a sulfonic group, carboxylic acid group, sulfuric group, phosphoric group, sulfide group and combinations thereof.

13. A process according to claim 1 wherein for (b) said agent that comprises one or more moieties that provide a negative charge comprises a sulfonic group.

14. A process according to claim 1 wherein said application is achieved, at least in part, by a method selected from the group consisting of padding, spraying, exhaustion, saturating and combinations thereof.

15. A process comprising applying, to a fiber, based on total fiber weight, from about 0.5% to about 5% of a treatment composition comprising a material selected from the group consisting of:
a.) a reactive agent comprising one or more reactive moieties and one or more moieties that provide a negative charge, said reactive agent comprising a material selected from the group consisting of butanetetracarboxylic acid, polymaleic acid and mixtures thereof;
b.) a reactive agent comprising two or more reactive moieties, said reactive agent comprising dimethyloldihydroxyethylene urea and said agent that comprises one or more moieties that provide a negative charge comprises a material selected from the group consisting of aminomethanesulfonic acid, taurine, isethionic acid and mixtures thereof; and
c.) mixtures of (a) and (b), and
d.) a catalyst selected from the group consisting of acids, latent acids and mixtures thereof.

16. An article comprising a fiber treated according to the process of claim 1.

17. A textile product comprising a fiber treated according to the process of claim 1.

18. An article comprising a fiber treated according to the process of claim 15.

19. A textile product comprising a fiber treated according to the process of claim 15.
